(19) United States
(12) Patent Application Publication
(10) Pub. No.: US 2007/0205846 A1
(43) Pub. Date: Sep. 6, 2007

(54) FILTER CIRCUIT

(75) Inventors: CHUN-JEN CHEN, Tu-Cheng (TW); SHOU-KUO HSU, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,480

(22) Filed: Aug. 11, 2006

(30) Foreign Application Priority Data
Mar. 2, 2006 (CN) 200610034117.7

(51) Int. Cl. H04B 3/04

(52) U.S. Cl. 333/20

(57) ABSTRACT

A filter circuit includes a signal source, an inductor, a load, and a compensator. The inductor and the load are connected between two terminals of the signal source in series. The compensator is connected in parallel with the inductor.

### FIELD OF THE INVENTION

The present invention relates to a filter circuit.

### DESCRIPTION OF RELATED ART

FIG. 1 shows a conventional filter circuit of a power supply circuit of an electric device such as a motherboard. The filter circuit includes a signal source V1, an inductor L1, a capacitor C1, and a load Z1. The inductor L1 and the load Z1 are connected between two terminals of the signal source V1 in series. One terminal of the signal source V1 is grounded. The capacitor C1 is connected in parallel with the load Z1. The signal source V1 outputs a signal to the load Z1 through filtering of the inductor L1 and the capacitor C1.

FIG. 2 shows a frequency response diagram of the filter circuit of FIG. 1. The horizontal-axis of FIG. 2 denotes a frequency of the signal after filtering, and the vertical-axis of FIG. 2 denotes a magnitude of the signal after filtering. When the frequency of the signal is 15.8 MHZ, a frequency response curve 10 of the signal has an 8.4 dB peak value. The peak value may magnify noise of the signal and input it to the load Z1, thereby the load Z1 may be influenced.

What is desired, therefore, is to provide a filter circuit which can reduce peak values therein effectively.

### SUMMARY OF THE INVENTION

In one preferred embodiment, a filter circuit includes a signal source, an inductor, a load, and a compensator. The inductor and the load are connected between two terminals of the signal source in series. The compensator is connected in parallel with the inductor.

Other advantages and novel features will become more apparent from the following detailed description when taken in conjunction with the accompanying drawings, in which:

### BRIEF DESCRIPTION OF THE DRAWINGS

FIG. 1 is a circuit diagram of a conventional filter circuit;

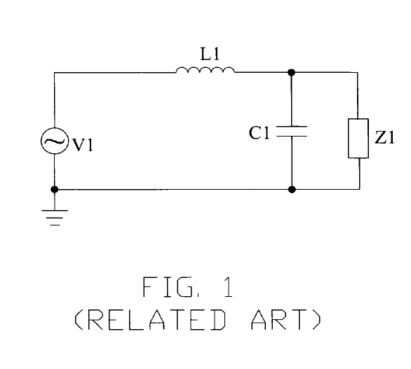

FIG. 2 is a frequency response graph of the filter circuit of FIG. 1;

FIG. 3 is a circuit diagram of a filter circuit in accordance with a preferred embodiment of the present invention; and

FIG. 4 is a frequency response graph of the filter circuit of FIG. 3.

### DETAILED DESCRIPTION OF THE INVENTION

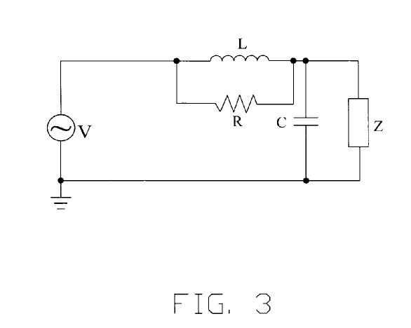

Referring to FIG. 3, a filter circuit in accordance with a preferred embodiment of the present invention is shown. The filter circuit includes a signal source V, an inductor such as a ferrite bead L, a capacitor C, a load Z, and a compensator such as a resistor R. The ferrite bead L and the load Z are connected between two terminals of the signal source V in series. One terminal of the signal source V is grounded. The resistor R is connected in parallel with the ferrite bead L. The capacitor C is connected in parallel with the load Z. The signal source V outputs a signal to the load Z through filtering of the ferrite bead L, the resistor R, and the capacitor C.

In this embodiment, a preferred formula for a value of the resistor R as follows:

$$R = \frac{Z \times \sqrt{L}}{2 Z \times \sqrt{C} - \sqrt{L}}$$

wherein Z, L, and C are respectively the values of the load Z, the ferrite bead L, and the capacitor C.

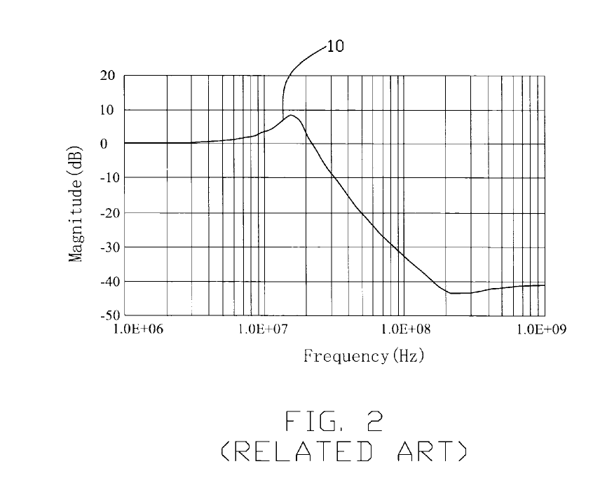

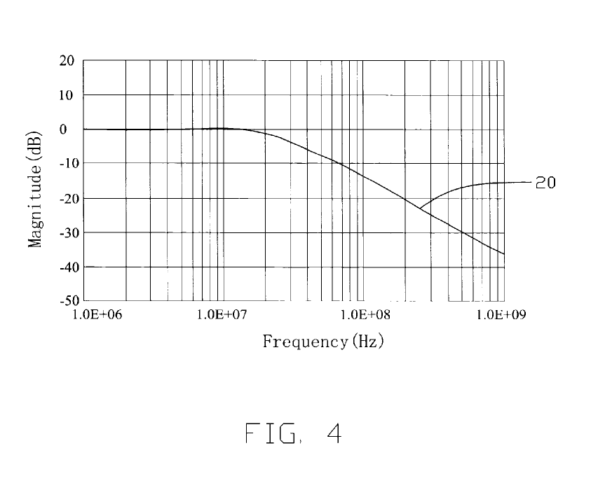

FIG. 4 shows a graph of a typical frequency response curve of the filter circuit of FIG. 3 when the above formula is used. Comparing the FIG. 4 to the FIG. 2, when the frequency of the signal is 15.8 MHZ, peak value of a frequency response curve 20 of FIG. 4 is less than the peak value of the frequency response curve 10 of FIG. 2.

It is believed that the present embodiment and its advantages will be understood from the foregoing description, and it will be apparent that various changes may be made thereto without departing from the spirit and scope of the invention or sacrificing all of its material advantages, the example hereinbefore described merely being a preferred or exemplary embodiment of the invention.

What is claimed is:

1. A filter circuit comprising:
a signal source;
an inductor;
a load; and
a compensator, the inductor and the load connected between two terminals of the signal source in series, the compensator connected in parallel with the inductor.

2. The filter circuit as claimed in claim 1, further comprising a capacitor, the capacitor connected in parallel with the load.

3. The filter circuit as claimed in claim 1, wherein the compensator is a resistor.

4. The filter circuit as claimed in claim 1, wherein the inductor is a ferrite bead.

5. A filter circuit adapted for connecting two terminals of a signal source, the filter circuit comprising:
an inductor;
a compensator;
a capacitor; and
a load, the inductor and the load connected between two terminals of the signal source in series, the compensator connected in parallel with the inductor, the capacitor connected in parallel with the load.

6. The filter circuit as claimed in claim 5, wherein the compensator is a resistor.

7. The filter circuit as claimed in claim 5, wherein the inductor is a ferrite bead.

8. A filter circuit consisting of:
a signal source;
an inductor;
a load;
a compensator; and
a capacitor, wherein the inductor and the load are connected between two terminals of the signal source in series, the compensator is connected in parallel with the inductor, the capacitor is connected in parallel with the load.

9. The filter circuit as claimed in claim 8, wherein the compensator is a resistor.

10. The filter circuit as claimed in claim 8, wherein the inductor is a ferrite bead.
